(19) United States
(12) Patent Application Publication
(10) Pub. No.: US 2018/0133639 A1
(43) Pub. Date: May 17, 2018

(54) REMOTE MONITORING OF AIR FILTER SYSTEMS

(71) Applicant: ROBOVENT PRODUCTS GROUP, INC., Sterling Heights, MI (US)

(72) Inventors: JOHN REID, TROY, MI (US); ANDREW REID, TROY, MI (US)

(21) Appl. No.: 15/813,675

(22) Filed: Nov. 15, 2017

Related U.S. Application Data
(60) Provisional application No. 62/422,245, filed on Nov. 15, 2016.

(51) Int. Cl. B01D 46/00; B01D 46/46

(52) U.S. Cl. CPC B01D 46/0086; B01D 46/46; B01D 46/0068; B01D 46/0082; B01D 46/0083

(57) ABSTRACT

A system and method for monitoring an air filtering system are disclosed. The system includes at least one station system attached to the air filtering system configured to monitor the air filtering system. The at least one station system includes an air filter microprocessor and an air filtering sensor to determine various aspects associated with the air filtering system and output sensed data. At least one location system is in communication with the at least one station system and also includes a location display for outputting and rendering a location graphical user interface based on the sensed data. At least one remote system is also in communication with the at least one station system and is configured to monitor and interact with the at least one location system and includes a remote display coupled to the remote microprocessor for outputting and rendering a remote graphical user interface based on the sensed data.

### CROSS-REFERENCE TO RELATED APPLICATIONS

This utility application claims the benefit of U.S. Provisional Application No. 62/422,245 filed Nov. 15, 2016. The entire disclosure of the above application is incorporated herein by reference.

### FIELD

The present disclosure relates generally to remote monitoring system and, more particularly to a remote monitoring system for air filtering systems.

### BACKGROUND

This section provides background information related to the present disclosure which is not necessarily prior art.

Air filtering is employed in a variety of industrial applications. The air filters serve to collect particulate matter from contaminating an environment, thereby promoting a clean and more consistent environment for the production and modifying of goods.

As stated above, air filtering systems are employed in a variety of industries. In many manufacturing industries, processes such as welding generate undesirable byproducts such as dust or hazardous substances. Separate work stations or work areas are often utilized to contain these substances produced during manufacturing operations.

Air filters are physical systems employing compressors, mesh structures, and other methods to prevent or remove the particulate matter. As such, the air filters are subject to wear and tear, and thus, are subject to failure and non-optimal operation. In current air filtering systems, constant monitoring is required to ensure that the air filters maintain integrity and an operable state. For example, if an air filter employs a motor to drive a fan associated with suctioning out particulate matter, and said motor is not operable, the air filter system's implementation may be frustrated.

Thus, in conventional industrial applications, a physical inspector is employed to visibly inspect each installation of an air filter. If a physical inspector is incapable of observing a failing or failed air filter, the industrial application associated with the air filter may be incapable of producing said goods, or produce said goods at a non-optimal level.

FIG. 1 illustrates an example of an air filtering system 100 employed at an industrial location. As shown, the air filtering system 100 is placed over a table (or station) 150. The table 150 may be employed to allow an industrial application to occur, such as welding, fixturing, molding, general assembly, or the like. The air filtering system 100 is configured to suction out particulate matter/byproducts of the industrial application, and other contaminants associated with the industrial application or introduced inadvertently.

As explained above, in the instance that the air filtering system 100 becomes inoperable or operating at a non-optimal condition, the industrial application associated with table 150 becomes frustrated.

### SUMMARY

This section provides a general summary of the present disclosure and is not a comprehensive disclosure of its full scope or all of its features and advantages.

It is an object of the present disclosure to provide a remote monitoring system for an air filtering system. The remote monitoring system includes at least one station system attached to the air filtering system at a station and configured to monitor the air filtering system. The at least one station system includes an air filter microprocessor and an air filtering sensor coupled to the air filter microprocessor and configured to determine various aspects associated with the air filtering system and output sensed data. The at least one station system also includes at least one station RX/TX device coupled to the air filter microprocessor for communicating the sensed data. At least one location system is at a location of the station and is in communication with the at least one station system for monitoring the at least one station system. The at least one location system includes a location microprocessor and at least one location RX/TX device coupled to the location microprocessor for communicating and receiving the sensed data. The at least one location system also includes a location display coupled to the location microprocessor for outputting and rendering a location graphical user interface based on the sensed data. At least one remote system is in communication with the at least one location system and the at least one station system and is configured to monitor and interact with the at least one location system and the at least one station system. The at least one remote system includes a remote monitoring microprocessor and at least one remote RX/TX device coupled to the remote monitoring microprocessor for receiving the sensed data. The at least one remote system includes a remote display coupled to the remote microprocessor for outputting and rendering a remote graphical user interface based on the sensed data.

It is another aspect of the present disclosure to provide a method of operating a remote monitoring system for air filtering systems. The method begins with the step of receiving an instruction to perform a sense operation with an air filter microprocessor of at least one station system coupled to the air filtering system based on one of a remote command and a predetermined interval. The method continues with the step of sensing the air filtering system using an air filtering sensor and outputting sensed data in response to receiving the instruction to perform the sense operation using the air filter microprocessor. The next step of the method is communicating the sensed data to at least one location system and at least one remote system using a station RX/TX device coupled to the air filter microprocessor. The method also includes the steps of receiving the sensed data from the station system using a location RX/TX device of at least one location system using a location microprocessor and updating a location display of the at least one location system using the location microprocessor. The method continues with the steps of receiving the sensed data from the station system using a remote RX/TX device of at least one remote system using a remote microprocessor and updating a remote display of the at least one remote system using the remote microprocessor. Next, determining whether the sensed data is over a predetermined threshold. The method concludes with the step of cleaning the air filtering system with a self-cleaning apparatus in response to the sensed data being over the predetermined threshold.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure, wherein:

FIG. 1 illustrates an example of an air filtering station implemented with a table/station provided for an industrial application;

FIG. 2 illustrates an example of a high-level architecture diagram incorporating the systems disclosed herein;

FIG. 3 illustrates an example of a system for monitoring a single station according to the aspects disclosed herein;

FIG. 4 illustrates an example of a method of operation associated with a processor employed to implement the system shown in FIG. 3;

FIG. 5 illustrates an example of a system for monitoring a location (employing one or more systems in FIG. 3) according to the aspects disclosed herein;

FIG. 6 illustrates a method of operation associated with a processor employed to implement the system shown in FIG. 5;

FIG. 7 illustrates an example of a system for monitoring one or more locations (employing one or more systems in FIG. 3) according to the aspects disclosed herein;

FIG. 8 illustrates a sample implementation of the systems shown in FIGS. 2, 4, and 6 according to aspects disclosed herein; and

FIGS. 9-12 illustrate various implementations of graphical user interfaces (GUI)s employable with the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, the failures of an air filtering system propagate to the industrial application that said air filtering systems are integrated with. Thus, the activity associated with the industrial application is compromised, and ultimately prohibited. Addressing these failures may be costly, as human resources are wasted to ensure integrity. Further, not addressing said failures leads to costly and burdensome delays in the activity associated with said industrial applications.

Disclosed herein are methods and systems for remotely monitoring air filtering systems. The aspects disclosed herein additionally allow for automatic rehabilitation of air filtering systems according to the aspects disclosed herein. Thus, employing the aspects disclosed herein, the implementation of air filtering systems is improved in both efficiency and costs.

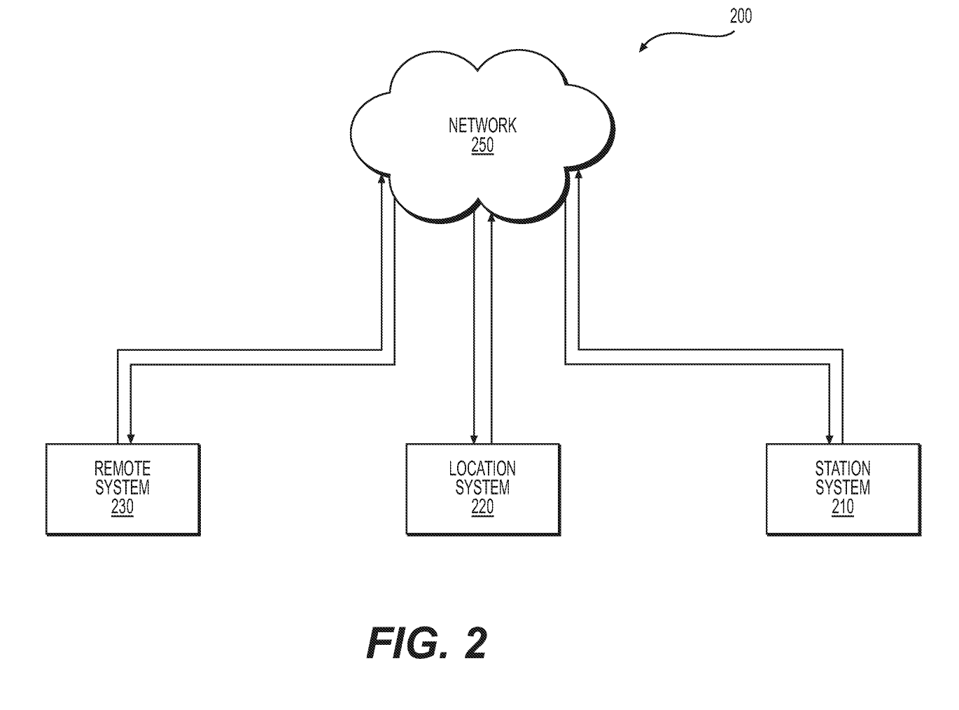

FIG. 2 illustrates an example of the various systems associated with an implementation of the systems and methods disclosed herein. As shown in FIG. 2, a remote monitoring system 200 for air filtering systems 100 includes a station system 210, a location system 220, and a remote system 230.

The systems 210, 220, 230 shown in FIG. 2 communicate to each other via a network 250. The network 250 may be any sort of local or wide area network (LAN or WAN) capable of providing a medium for wired or wireless communication. Further, each of the systems 210, 220, 230 shown herein may be employed with a variety of data storage techniques, including integrated memory, a remote hard drive, cloud storage, and the like.

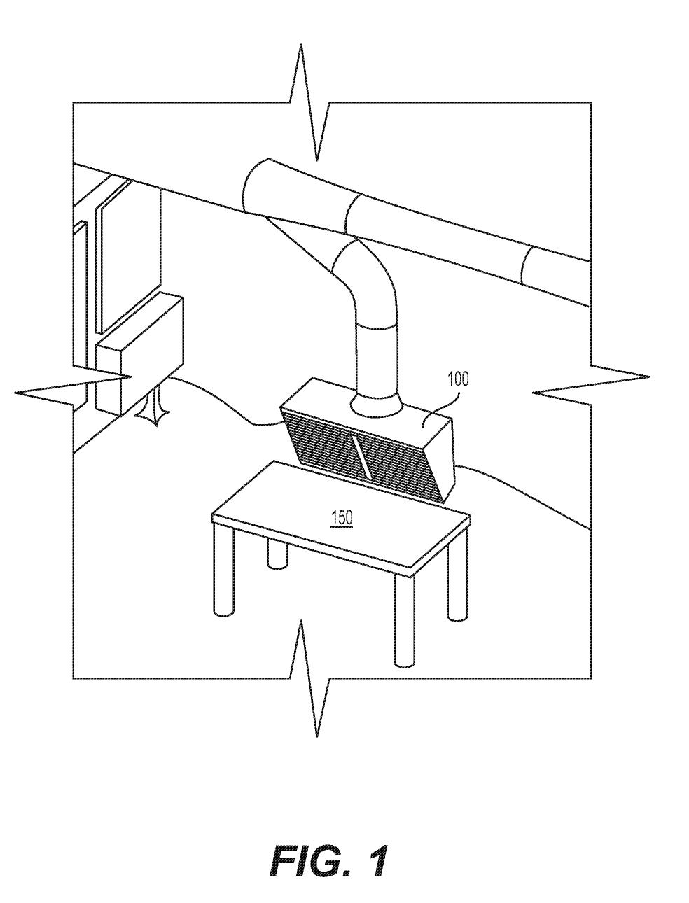

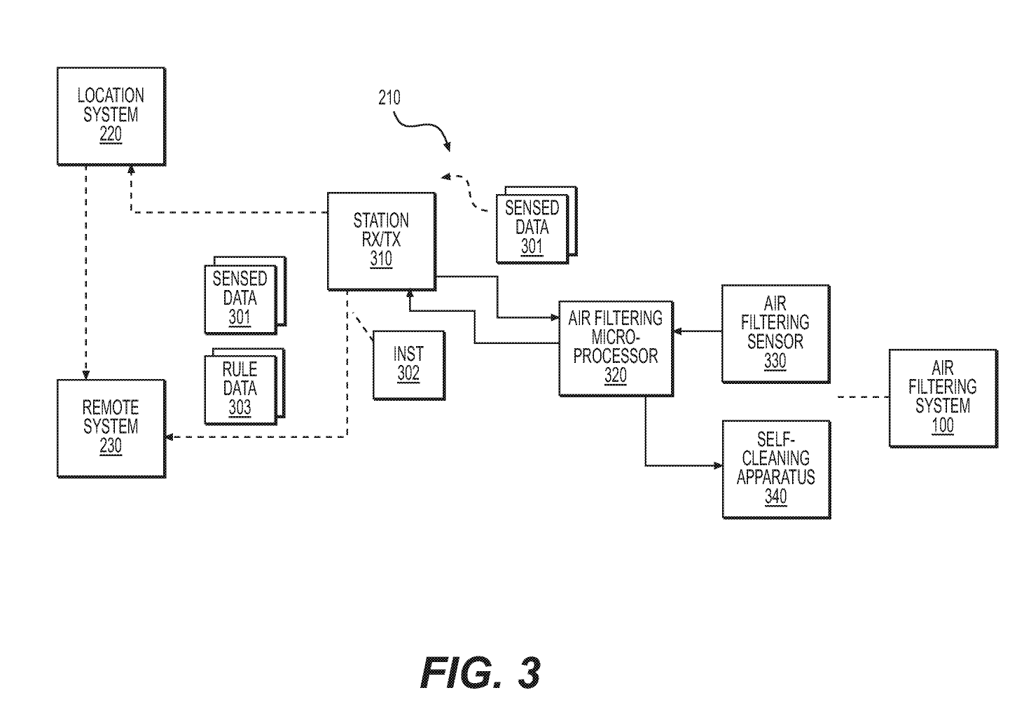

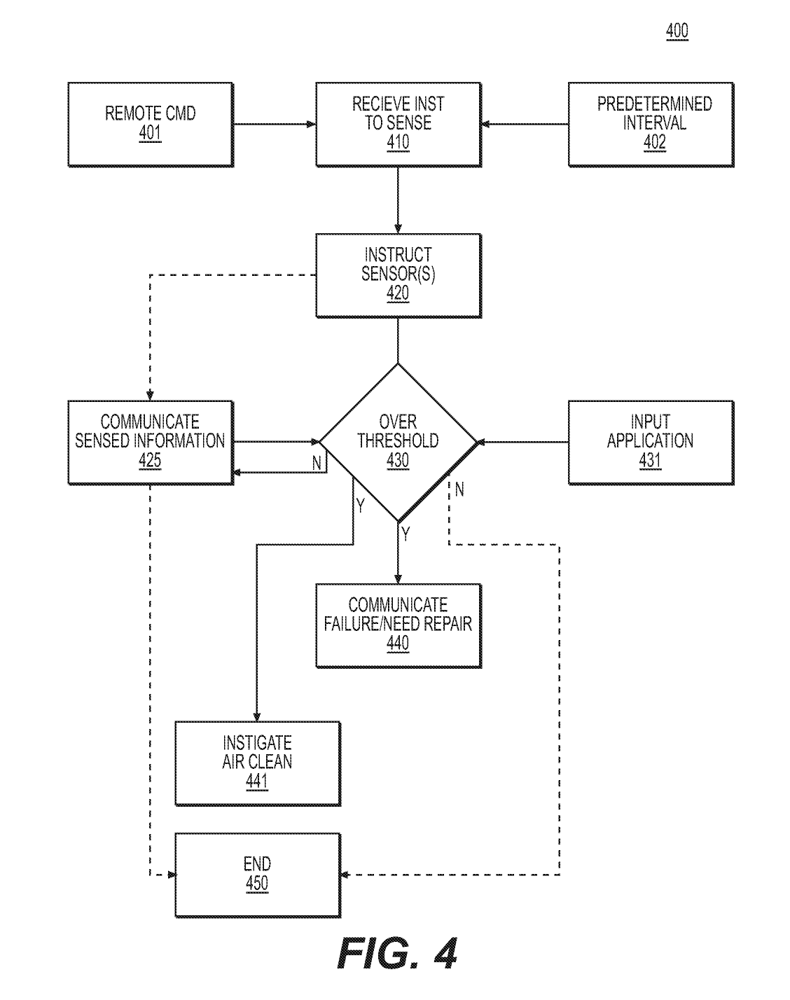

The station system 210 is attached to the air filtering system 100 (as shown in FIG. 1), and is configured to monitor an individual air filtering system 100. The operation of the station system 210 is described in further detail in FIGS. 3 and 4.

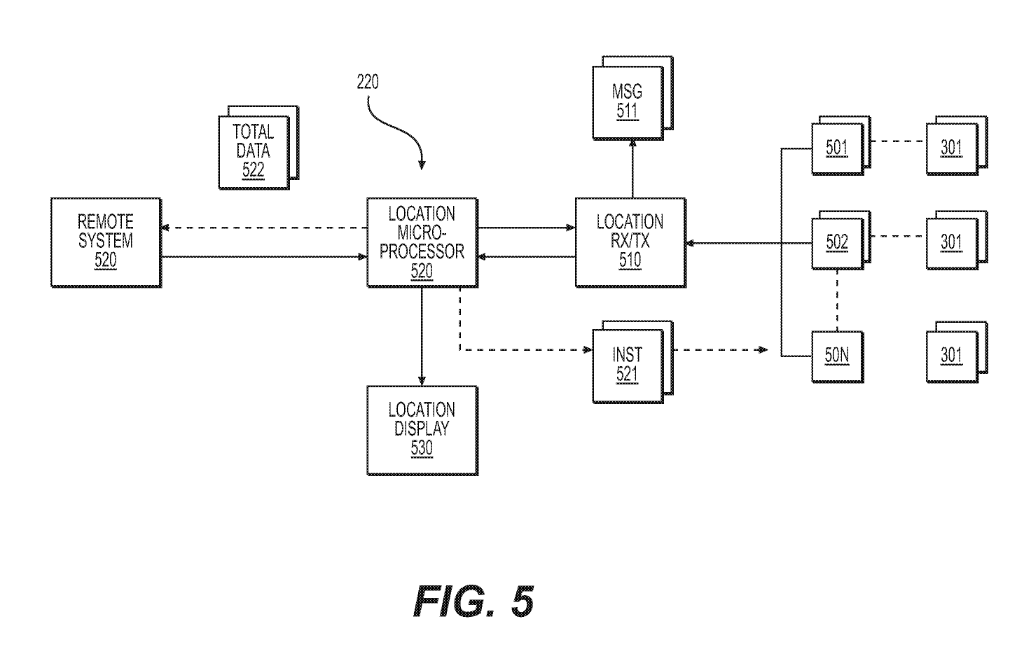

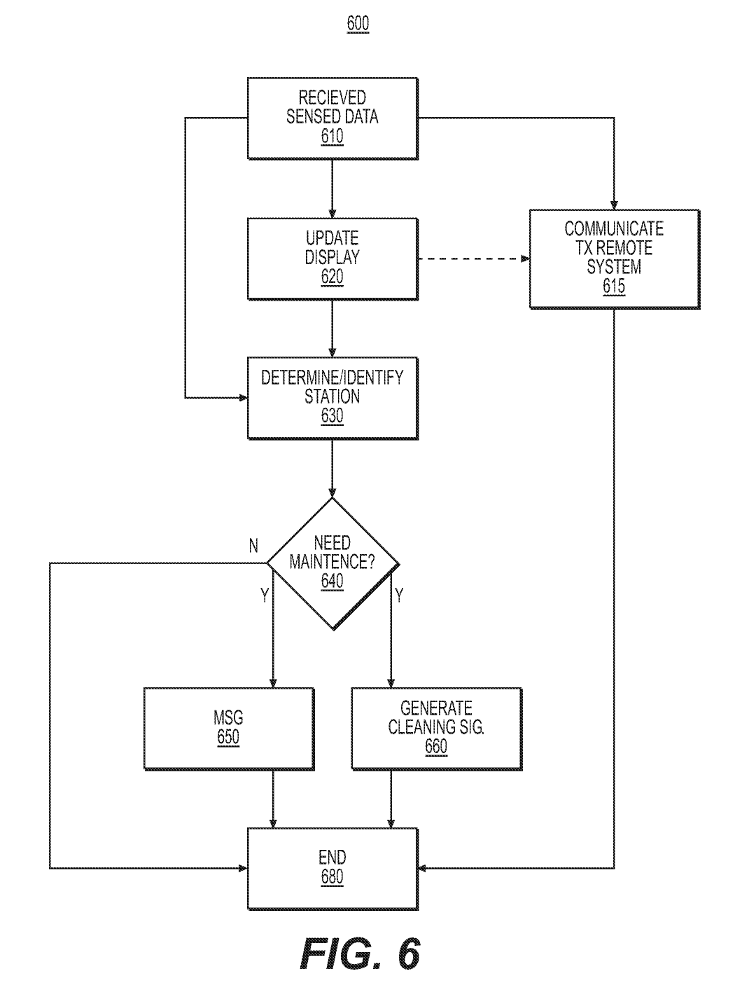

The location system 220 is installed in a specific location associated with the installation of one or more air filtering systems 100 and station systems 210. For example in a situation where multiple air filtering systems are installed in a factory or a plant, the location system 220 may be installed in a centralized location either in the factory or a plant, or at a remote location. As such, information generated from each of the station systems 210 may be configured to communicatively transmit/receive information (either in a wired or wireless manner) with the location system 220. The location system 220 will be described in greater detail below in FIGS. 5 and 6.

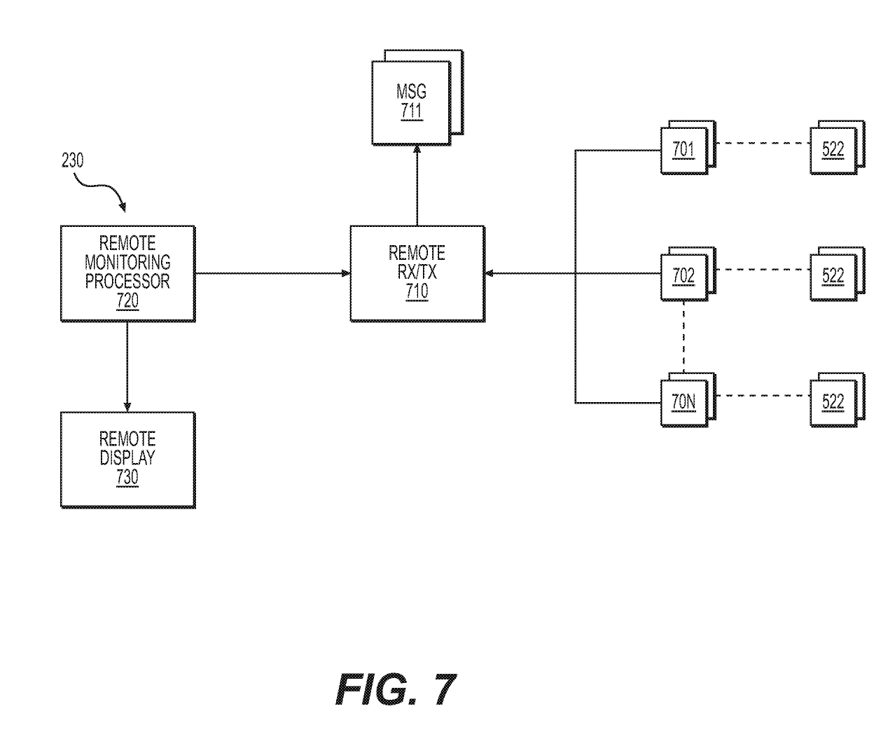

The remote system 230 may be communicatively coupled to one or more location systems 220, and be situated in a remote location, such as a central location (or alternatively, at one of the locations in which the location server 220 or the station system 210 is located). A sample implementation of a remote server is shown in FIG. 7.

There will be various permutations of the remote monitoring system 200 disclosed herein, and in one embodiment at least one station system 210, one location system 220, and one remote system 230 will be implemented. Alternatively, the at least one station system 210 may be selectively provided with either one of the location system 220 and/or remote system 230.

FIG. 3 illustrates an example of a station system 210 according to the aspects disclosed herein. As shown in FIG. 3, the station system 210 includes at least a station RX/TX device 310, an air filter microprocessor 320 and an air filtering sensor 330. In an alternate embodiment, the air filter sensor 330 may selectively be provided with a self-cleaning apparatus 340 (i.e., an air filtering cleaner), discussed below.

The station RX/TX device 310 is any circuit device capable of communicating (either in a wired or wireless manner) to a remotely provided third-party (such as location system 220 or remote system 230). The station RX/TX device 310 receives information from a third-party and propagates said information to the air filter microprocessor 320, or alternatively and additionally to, receives information from the air filter microprocessor 320 to propagate to a third-party according to the aspects disclosed herein.

The air filter microprocessor 320 as well as the various data and signals shown in FIG. 3 will be described in greater detail in FIG. 4.

The air filtering sensor 330 is a sensor configured to determine various aspects associated with the air filtering system 100. These aspects may include determining how much particulate matter is trapped in the air filtering system 100, whether the electronic components associated with the air filtering system 100 are operational, or log the amount of usage of various sub-systems associated with the air filtering system 100.

Some air filtering systems 100 may be equipped for self-cleaning. Thus, as best shown in FIG. 3, the station system 210 of the remote monitoring system 200 includes a self-cleaning apparatus 340. The self-cleaning apparatus 340 may include, but is not limited to a mechanical suction system, air blower, washer, or the like, capable of cleaning the air filtering system 100.

FIG. 4 illustrates a method 400 of operation associated with the air filter microprocessor 320. The air filter microprocessor 320 may be programmed with method 400, or variations of method 400 that may be disclosed herein.

In operation 410, an instruction to perform one or more sense operations is received. As shown in FIG. 4, this instruction may come from one, some, or all of the following described sources. For example, the instruction may be sourced from a remote command 401, at a predetermined interval 402, or another source not shown or described (for example, every time the industrial application associated with the air filtering system 100 is initiated).

After an instruction is received, the method 400 proceeds to operation 420, wherein one, some, or all of the sensing functions implemented as part of the air filtering sensor 330 are instructed to perform a sensed operation. The results of operation 420 are that sensed data 301 is produced reflecting the instructions sensing functions associated with operation 420. This information is propagated to the air filter microprocessor 320.

In one example, prior to method 400 proceeding to operation 430, the method 400 may proceed to operation 425, where the sensed data 301 is communicated to a remote party via station RX/TX device 310. In some implementations, the method 400 may proceed to operation 430 after, or end 450 (based on an implementer of configuration choices of the station system 210).

In operation 430, a determination is made as to whether the sensed data 301 is over a specific predetermined threshold (for the one, some, or all categories sensed in operation 420). If at least one of the categories is over the predetermined threshold, the method may proceed to either operation 440, or alternatively to operation 441.

In an alternate embodiment, the determination in operation 430 may be augmented with additional information (rule data 303), which is reflected by the input operation 431. The station system 210 may be provided with information about the future use associated with the affiliated station. As such, the determination may reflect this future use. For example, if the station is affiliated with multiple welders/welding systems, the threshold may adjust to a new or lower number for a category to compensate that the station will undergo more usage. As such, the predictive failure capabilities of the station may dynamically adjust based on provided data indicating usage of the station affiliated with the station system 210.

If the determination in operation 430 is no, the method 400 may proceed to operation 425 where the sensed data 301 is communicated to a third-party, or alternatively, the method 400 may end 450.

In operation 440, the sensed data 301 (which may include which portions of the air filtering system 100 is failing or in need of pre-emptive repair) is communicated to a third-party, such as location system 220 and/or the remote system 230 (which will be described in greater detail below). Alternatively, the station RX/TX device 310 may be configured to automatically communicate to a third-party responsible with maintaining the air filtering system 100.

In operation 441, the air filter microprocessor 320 may be configured to propagate an instruction to instigate one of the mechanisms associated with fixing and ameliorating any detected problems with the air filtering system 100 (if available).

Operations 440 and 441 may be implemented in a combined fashion. As such, some categories of detected problems associated with the sensed data may be ameliorated by the self-cleaning apparatus 340 (i.e., an associated mechanism or apparatus provided therein), and some may require third-party intervention (i.e., via operation 440 and via a signal communicated via station RX/TX device 310).

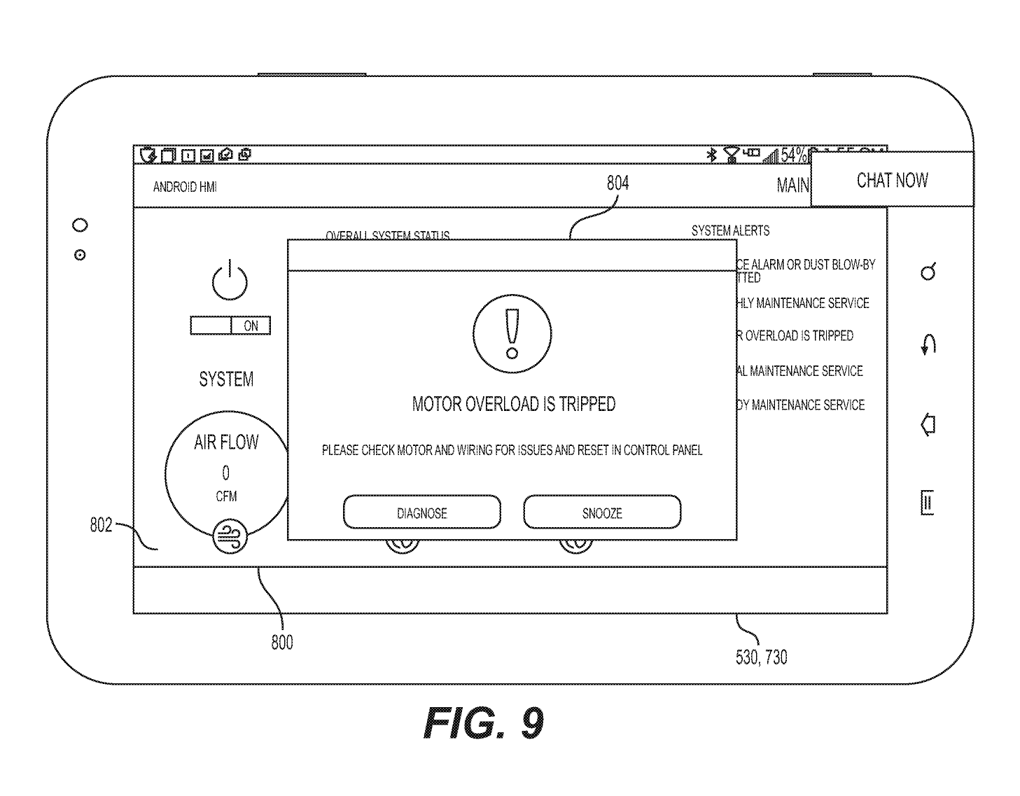

FIG. 5 illustrates an example of the location system 220 according to the aspects disclosed herein. A location system 220 is implemented to monitor at least one or more station systems 210. The location system 220 includes a location RX/TX device 510 and a location microprocessor 520. In some cases, the location microprocessor 520 may be coupled to a location display 530. The location display 530 is any digital display capable of outputting and rendering digital location graphical user interfaces (GUI)s associated with the aspects disclosed herein. Several examples of the location GUI are described with regards to FIGS. 9-12.

The location RX/TX device 510 is similar to the one described in the station system 210, and as such, a detailed explanation will be omitted. The location microprocessor 520 and the various signals shown in FIG. 5 are described in FIG. 6.

FIG. 6 illustrates a method 600 explaining the various operations that the location microprocessor 520 is configured to perform.

In operation 610, sensed data 301 is received from one or more station systems 210 (as shown by data signals 501, 502 . . . , 50n—with each data signal corresponding to a respective station system 210). The method 600 may proceed to operation 615, 620, or 630.

In operation 615, communication with a remote system 230 via the location RX/TX device 510 is established. The remote system 230 will be described in FIG. 7 with more detail.

In operation 620, the location display 530 is updated. The location display 530 and its various permutations will be described in detail in FIGS. 9-12. The method 600 may proceed to operation 630 after, or alternatively, to the end 670.

In operation 630, the sensed data 301 (i.e. any of 501-50n) received in operation 610 is determined/identified based on a source of the sensed data 301 and a determination is made as to whether the sensed data indicates any information indicating a failure of one or more categories associated with the air filtering system 100. In one implementation, the indication of a failed one or more category may be communicated from the station system 210.

In another implementation, this failure may be identified by the location system 220 in operation 640. Similar to the operation described in FIG. 4, a determination as to whether a failure has occurred or will occur (through predictive metrics) may be performed by determining if the sensed data 301 received is over a predetermined threshold. As described above, the predetermined threshold may be adjusted based on usage (either sensed or inputted), and as such, the prediction of failure of one or more categories of the air filtering system 100 may dynamically update accordingly.

Operations 650 and 660 describe two techniques to ameliorate the problem or failure determined in operation 640. In one instance, as described in operation 650, a message 511 is generated to a service ear-marked to repair or maintain the air filtering system 100.

In operation 660, a signal indicating maintenance is generated and propagated back to the station system 210. As such, in this case, if the station system 210 is capable of performing a self-maintenance operation, the station system 210 is configured to perform said operation based on receiving the instruction 521. After both operations 650 and 660 commence, the method 600 proceeds to end 670.

FIG. 7 illustrates the remote system 230 according the aspects disclosed herein. The remote system 230 may be substantially similarly configured as the location server 220, however, the remote system 230 is configured to monitor and interact with multiple location systems 220. The remote system 230 includes a remote RX/TX device 710, a remote monitoring processor 720, and a remote display 730. These components perform similar functions as described in FIG. 5, with the main difference being noted above. FIGS. 9-12 illustrate examples of the remote GUI.

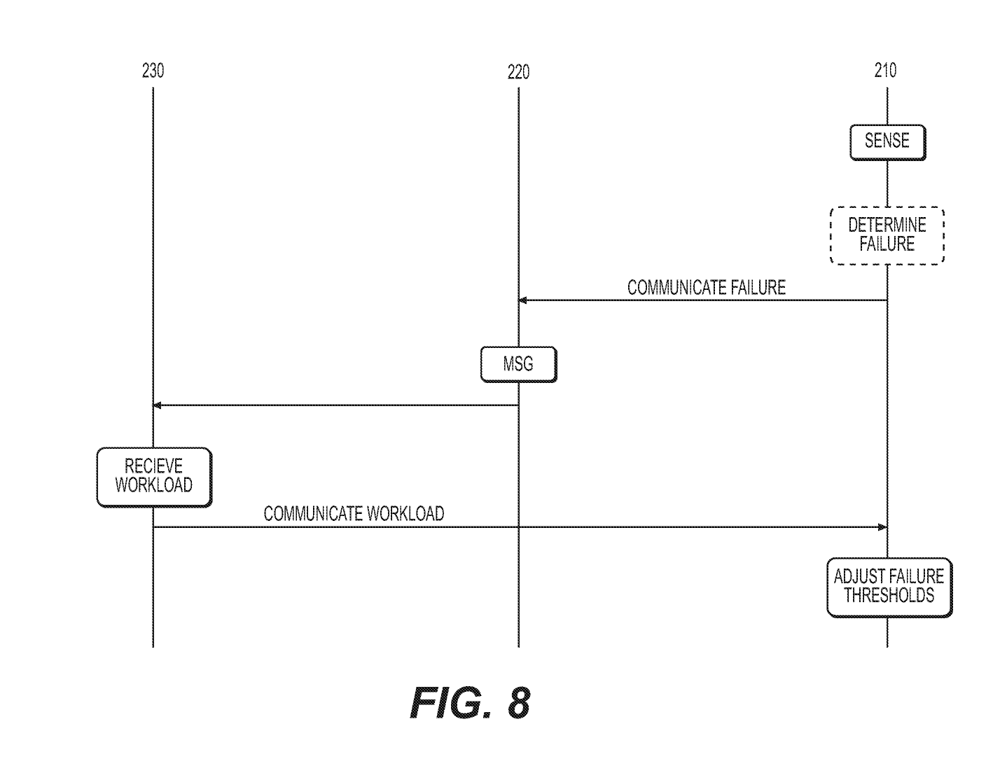

FIG. 8 illustrates one example of implementation employing the aspects disclosed herein. As noted above, the implementation of the various systems, the number of systems implemented, as well as the alternate embodiments may vary due to a specific setup or need.

FIGS. 9-12 illustrate example display information associates with the aspects disclosed herein. These display screens may be implemented employing any of the aspects disclosed above, and be delivered to either or both of displays 530 and 730 for digital rendering.

As shown in FIG. 9, the display 530, 730 presents the GUI 800 (i.e., location GUI and/or remote GUI) to alert a user or update a view or screen of the display 530, 730 (e.g., error screen 802) of an error 804 associated with a single air filtering system 100. As shown, the sample error shown on the error screen 802 of the GUI 800 is associated with a motor overload, and a user may utilize other screens or elements of the GUI 800 to diagnose or even fix the problem. In some cases, the error (e.g., error 804) may be automatically or selectively communicated to a party capable of or responsible for maintaining the air filtering system 100 and associated equipment.

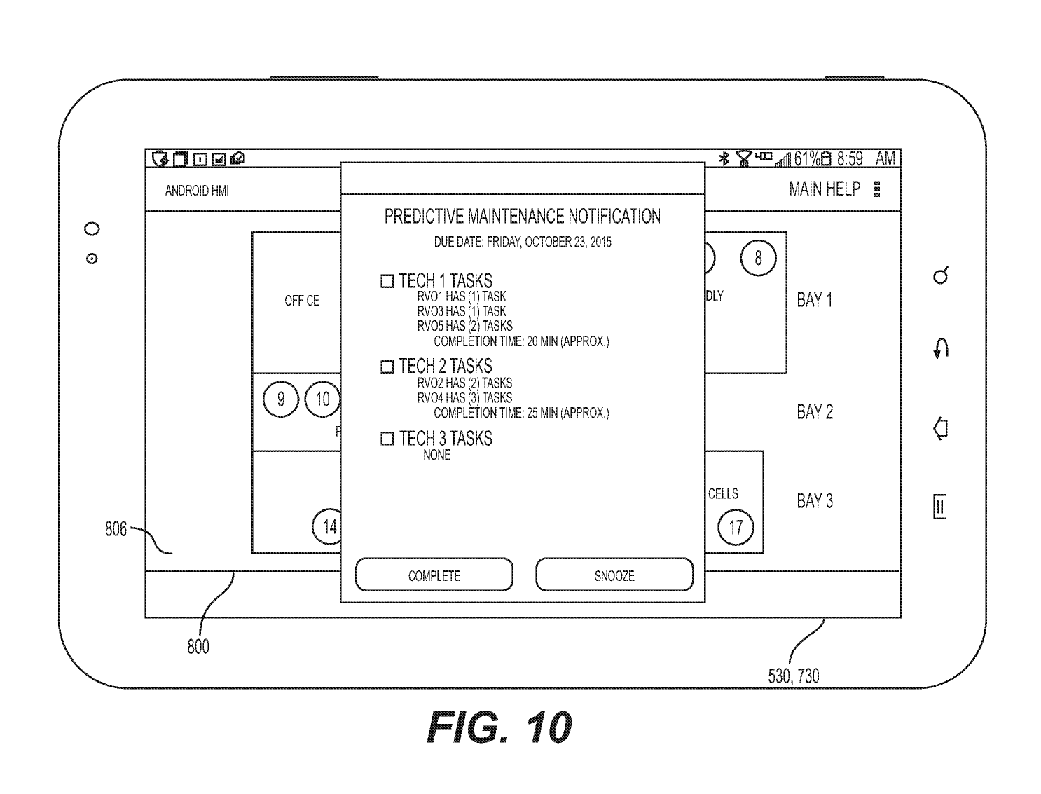

As shown in FIG. 10, the display 530, 730 incorporates a human machine interface (HMI) screen 806 to allow a user to enter data associated with the predictive usage of a single (or multiple) station systems 210. This information may be selectively entered as shown, or entered via a data file or another source. In some cases, the usage data may be estimated based on prior use associated with the station system 210. Thus, the prior use may be employed to interpolate future use.

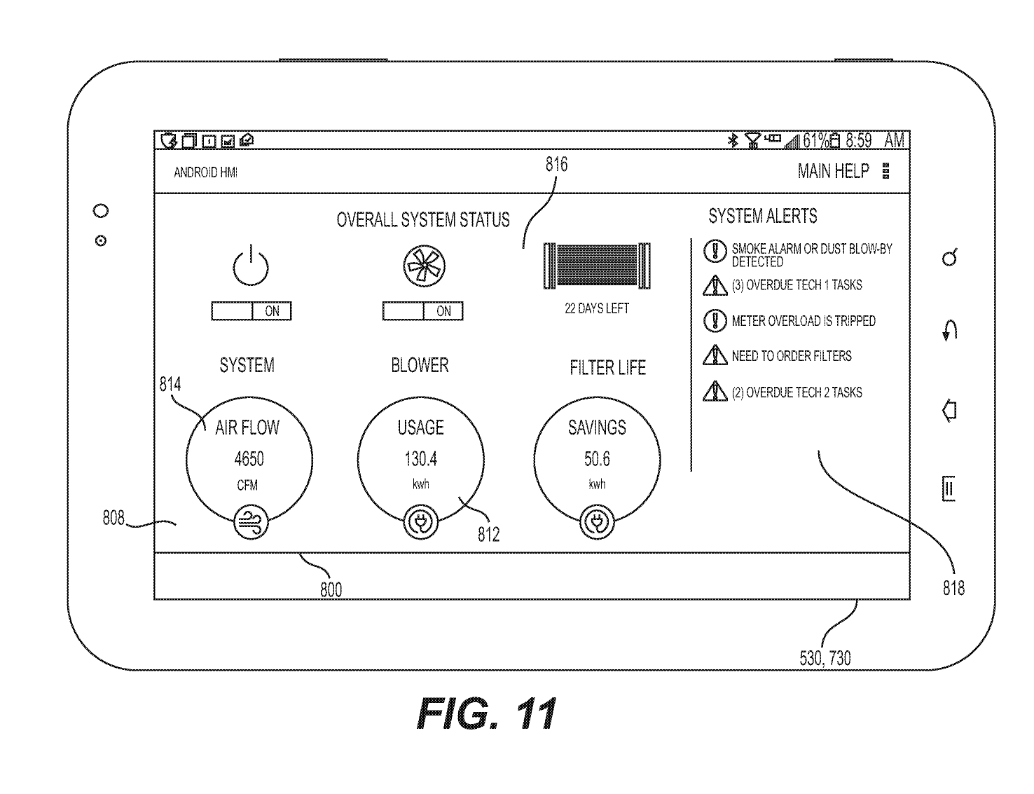

As shown in FIG. 11, the display 530, 730 presents a status screen 808 is provided to show statistics 812, 814, 816 associated with a single air filtering station system 210. As such, various performance metrics or statistics 812, 814, 816 may be recorded, such as, but not limited to energy usage 812, dust cleaned, overall performance 814, system status 816, and the like. Further, notes may be stored or automatically generated per each air filtering station system 210, recording when maintenance was performed, what maintenance was performed, and other alerts/concerns 818.

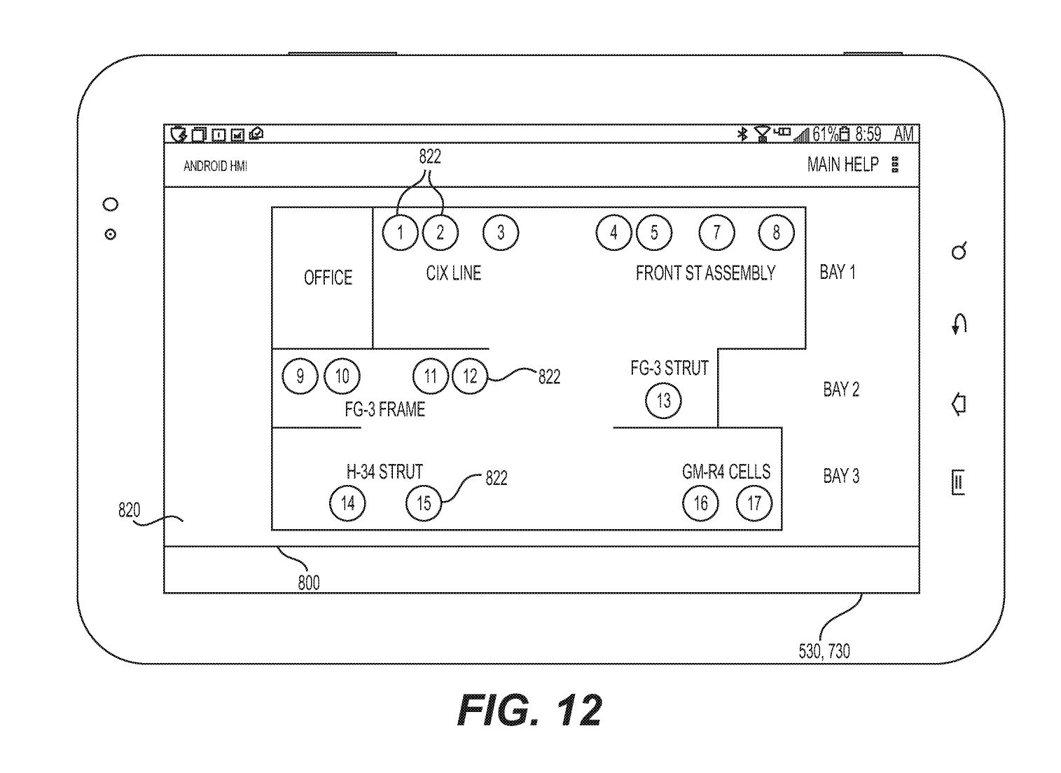

As shown in FIG. 12, multiple stations systems 210 may be monitored at a single location. Thus, the GUI 800 can present a station selection screen 820 in which a specific station system 210 may be selected, and the status screen 808 shown in FIG. 11 may be initiated. More specifically, the station selection screen 820 allows the user to select the specific station system 210 represented graphically on the GUI 800 presented by the display 530, 730 by station selectors 822 on the station selection screen 820.

Certain of the devices shown include or are implemented with a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 4, 6, and 8. The disclosed devices, components, and systems contemplate using or implementing any suitable technique for performing the steps illustrated in these figures. Thus, FIGS. 4, 6, and 8 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A remote monitoring system for an air filtering system, comprising:
at least one station system attached to the air filtering system at a station and configured to monitor the air filtering system;
said at least one station system including an air filter microprocessor and an air filtering sensor coupled to said air filter microprocessor and configured to determine various aspects associated with the air filtering system and output sensed data and at least one station RX/TX device coupled to said air filter microprocessor for communicating the sensed data;
at least one location system at a location of the station and in communication with said at least one station system for monitoring said at least one station system;
said at least one location system including a location microprocessor and at least one location RX/TX device coupled to said location microprocessor for communicating and receiving the sensed data and a location display coupled to said location microprocessor for outputting and rendering a location graphical user interface based on the sensed data;
at least one remote system in communication with said at least one location system and said at least one station system and configured to monitor and interact with said at least one location system and said at least one station system; and
said at least one remote system including a remote monitoring microprocessor and at least one remote RX/TX device coupled to said remote monitoring microprocessor for receiving the sensed data and a remote display coupled to said remote microprocessor for outputting and rendering a remote graphical user interface based on the sensed data.

2. The system as set forth in claim 1, wherein said air filter microprocessor is configured to:
receive an instruction to perform a sense operation with said air filter microprocessor based on one of a remote command and a predetermined interval;
sense the air filtering system using said air filtering sensor and output sensed data in response to receiving the instruction to perform the sense operation;
determine whether the sensed data is over a predetermined threshold; and
communicate the sensed data to at least one of said at least one location system and said at least one remote system using said station RX/TX device.

3. The system as set forth in claim 2, wherein said air filter microprocessor is further configured to:
receive rule data provided by an input operation; and
augment the determination whether the sensed data is over the predetermined threshold with the rule data.

4. The system as set forth in claim 2, wherein said air filter microprocessor is further configured to communicate the sensed data to a third party using said station RX/TX device in response to the sensed data being over the predetermined threshold.

5. The system as set forth in claim 2, wherein said at least one station system includes a self-cleaning apparatus including at least one of a mechanical suction system and air blower and washer and wherein said air filter microprocessor is further configured to clean the air filtering system with said self-cleaning apparatus in response to the sensed data being over the predetermined threshold.

6. The system as set forth in claim 2, wherein said location microprocessor is configured to:
receive the sensed data from said at least one station system using said location RX/TX device;
update said location display;
identify said at least one station system based on the sensed data; and
determine if the sensed data indicates a failure associated with the air filtering system.

7. The system as set forth in claim 6, wherein said location microprocessor is configured to propagate a signal back to said at least one station system in response to the sensed data indicating the failure associated with the air filtering system.

8. The system as set forth in claim 6, wherein said location microprocessor is configured to generate a message to a service ear-marked to repair the air filtering system in response to the sensed data indicating the failure associated with the air filtering system.

9. The system as set forth in claim 2, wherein said remote microprocessor is configured to:
receive the sensed data from said at least one station system using said remote RX/TX device;
update said remote display;
identify said at least one station system based on the sensed data; and
determine if the sensed data indicates a failure associated with the air filtering system.

10. The system as set forth in claim 9, wherein said remote microprocessor is configured to propagate a signal back to said at least one station system in response to the sensed data indicating the failure associated with the air filtering system.

11. The system as set forth in claim 9, wherein said remote microprocessor is configured to generate a message to a service ear-marked to repair the air filtering system in response to the sensed data indicating the failure associated with the air filtering system.

12. The system as set forth in claim 1, wherein at least one of said location graphical user interface and said remote graphical user interface includes an error screen for alerting a user of an error associated with the air filtering system.

13. The system as set forth in claim 1, wherein at least one of said location graphical user interface and said remote graphical user interface includes a status screen to show statistics associated with said station system including at least one of energy usage and dust cleaned and overall performance and system status.

14. The system as set forth in claim 1, wherein at least one of said location graphical user interface and said remote graphical user interface includes a station selection screen for selecting one of said at least one station system.

15. A method of operating a remote monitoring system for air filtering systems comprising the steps of:
receiving an instruction to perform a sense operation with an air filter microprocessor of at least one station system coupled to the air filtering system based on one of a remote command and a predetermined interval;
sensing the air filtering system using an air filtering sensor and outputting sensed data in response to receiving the instruction to perform the sense operation using the air filter microprocessor;
communicating the sensed data to at least one location system and at least one remote system using a station RX/TX device coupled to the air filter microprocessor;
receiving the sensed data from the station system using a location RX/TX device of at least one location system using a location microprocessor;
updating a location display of the at least one location system using the location microprocessor;
receiving the sensed data from the station system using a remote RX/TX device of at least one remote system using a remote microprocessor;
updating a remote display of the at least one remote system using the remote microprocessor;
determining whether the sensed data is over a predetermined threshold; and
cleaning the air filtering system with a self-cleaning apparatus in response to the sensed data being over the predetermined threshold.

16. The method as set forth in claim 15, further including the steps of:
receiving rule data provided by an input operation using the air filter microprocessor; and
augmenting the determination whether the sensed data is over the predetermined threshold with the rule data using the air filter microprocessor.

17. The method as set forth in claim 15, further including the step of communicating the sensed data to a third party using the station RX/TX device in response to the sensed data being over the predetermined threshold using the air filter microprocessor.

18. The method as set forth in claim 15, further including the steps of:
identifying the at least one station system based on the sensed data using the location microprocessor;
determining if the sensed data indicates a failure associated with the air filtering system using the location microprocessor; and
propagating a signal back to said at least one station system in response to the sensed data indicating the failure associated with the air filtering system using the location microprocessor.

19. The method as set forth in claim 15, further including the step of generating a message to a service ear-marked to repair the air filtering system in response to the sensed data indicating the failure associated with the air filtering system.

20. The method as set forth in claim 15, further including the steps of:
identifying the at least one station system based on the sensed data using the remote microprocessor;
determining if the sensed data indicates a failure associated with the air filtering system using the remote microprocessor; and
propagating a signal back to said at least one station system in response to the sensed data indicating the failure associated with the air filtering system using the remote microprocessor.
